(19) United States
(12) Patent Application Publication
(10) Pub. No.: US 2002/0088788 A1
(43) Pub. Date: Jul. 11, 2002

(54) Thermal warming garments for user temperature management

(75) Inventor: Arlen C. West, East Peoria, IL (US)

Correspondence Address: Robert E. Muir, Esq., Husch & Eppenberger, LLC, Suite 1400, 401 Main Street, Peoria, IL, 61602-1241, US

(73) Assignee: Wesco, Inc.

(21) Appl. No.: 10/008,341

(22) Filed: Nov. 13, 2001

Related U.S. Application Data
(63) Continuation-in-part of application No. 09/588,393, filed on Jun. 6, 2000, now Pat. No. 6,331,695.
Application No. 09/588,393 is a continuation-in-part of application No. 09/273,907, filed on Mar. 22, 1999, now Pat. No. 6,078,026.
(60) Provisional application No. 60/079,455, filed on Mar. 26, 1998.

(51) Int. Cl. H05B 3/36

(52) U.S. Cl. 219/211; 219/212; 219/543

(57) ABSTRACT

A thermal warming garment for user temperature management having at least one heating element matrix associated therewith, wherein the thermal warming garment has a top portion and a lower portion, wherein the lower portion has integral feet portions. The thermal warming garment is preferably powered by a battery power pack operatively connected to the at least one heating element matrix via a conductive wire.

### CROSS-REFERENCES

The present application is a continuation-in-part of my co-pending U.S. application Ser. No. 09/588,393 filed Jun. 6, 2000, entitled “Thermal Warming Blanket for Patient Temperature Management.” U.S. application Ser. No. 09/588,393 is a continuation-in-part of my U.S. application No. 09/273,907, which was filed on Mar. 22, 1999, issued as U.S. Pat. No. 6,078,026 on Jun. 20, 2000, and is entitled “Thermal Warming Blanket for Patient Temperature Management.” U.S. application No. 09/273,907 and U.S. Pat. No. 6,078,026 are based on the abandoned U.S. Provisional Application No. 60/079,455, filed Mar. 26, 1998 and entitled “Thermal Warming Blanket for Patient Temperature Management.” All of these pending or abandoned applications and the above-referenced patent are incorporated herein by reference.

### PRIORITY

The present application claims the benefit of co-pending U.S. patent application No. 09/588,393 filed Jun. 6, 2000 and having a priority date of Mar. 26, 1998 from U.S. application No. 09/273,907, filed on Mar. 22, 1999, now U.S. Pat. No. 6,078,026, issued Jun. 20, 2000, and U.S. Provisional Application No. 60/079,455 filed Mar. 26, 1998, now abandoned.

### TECHNICAL FIELD OF THE INVENTION

This invention relates generally to warming devices and more particularly to thermal warming garments for user temperature management.

### DESCRIPTION OF THE RELATED ART

In many settings of daily life, in both work and recreation, a person may be subjected to cold climates. Exposure to cold is a common problem for those who work or recreate outside. For example, construction workers are often subjected to extremely cold temperatures, resulting in discomfort and downtime. Consider, for example, the great many settings in which construction workers labor in numbing winter cold. Active control of one's body temperature under these circumstances minimizes the risk of hypothermia and also enhances efficiency and effectiveness in performing the task at hand. Spectators at athletic events and participating athletes are often subjected to cold temperatures as well. It is well known that one could use insulated clothing to minimize body heat loss in a cold environment. However, there are many problems associated with the use of insulated clothing. Insulated clothing can be bulky, uncomfortable and aesthetically unappealing. Insulated clothing of special fabrics is expensive. The above are only a few examples of the many types of activities performed in cold weather conditions. There are numerous other situations where one may be subjected to unpleasant exposure to cold weather.

In addition to insulated clothing, some high technology environment suits are known to provide heating and warmth for particular situations. The advantages of such garments, however, are limited in that often, they are total environment suits that include a separate thermal unit connected by hoses, or the like, with a thermal barrier and insulated thermal control garment. Thus, while these garments may be appropriate for a limited number of circumstances, such as space exploration or in some specialized terrestrial context, there remain a great number of situations in which an individual is subjected to excessive cold and in which this known high technology approach is simply too impractical and costly.

The present invention is directed to overcoming one or more of the problems or disadvantages set forth above.

### SUMMARY OF THE INVENTION

An aspect of the present invention is to provide an apparatus for overcoming one or more of the problems and disadvantages set forth above.

It is an aspect of this invention to provide a thermal warming garment for providing comfort and maintaining heat.

Another aspect of this invention is to provide a self contained, versatile thermal warming garment that any individual, such as a worker, sportsman, spectator, military personnel, etc., may use to help keep warm.

Another aspect of this invention to provide a portable power source to be connected to the thermal warming garment.

In yet another aspect of the present invention, there is provided a disposable thermal warming garment having at least one heating element matrix for one-time use including a sheet of plastic film having upper and lower sides, at least one printed circuit associated with the sheet of plastic film, the at least one heating element matrix including at least one printed circuit on one side of the sheet of plastic film, a cover extending over the at least one printed circuit side of the sheet of plastic film, means for connecting the heating element matrix with a power source and means for controlling the temperature of the heating element matrix.

In yet another aspect of the present invention, there is provided a reusable thermal warming garment having at least one heating element matrix including a sheet of plastic film having upper and lower sides, at least one printed circuit associated with the sheet of plastic film, the at least one heating element matrix including at least one printed circuit on one side of the sheet of plastic film, a cover extending over the at least one printed circuit side of the sheet of plastic film, means for connecting the at least one heating element matrix with a power source and means for controlling the temperature of the at least one heating element matrix.

In still another aspect of the present invention, there is provided a disposable thermal warming garment having at least one heating element matrix for one-time use including a sheet of polyester film having upper and lower sides; at least one printed circuit associated with one side of the sheet of polyester film; a polyester cover extending over the at least one printed circuit at said one side of the sheet of polyester film and means for connecting the at least one heating element matrix to a power source.

In still another aspect of the present invention, there is provided a reusable thermal warming garment having at least one heating element matrix including a sheet of polyester film having upper and lower sides; at least one printed circuit associated with one side of the sheet of polyester film; a polyester cover extending over the at least one printed circuit at said one side of the sheet of polyester film and means for connecting the at least one heating element matrix to a power source.

In yet still another aspect of the present invention, there is provided a disposable thermal warming garment having at least one heating element matrix for one-time use including a sheet of polyethylene film having upper and lower sides; at least one printed circuit associated with one side of the sheet of polypropylene film; a polypropylene cover extending over the at least one printed circuit at said one side of the sheet of polyethylene film and means for connecting the at least one heating element matrix to a power source.

In yet still another aspect of the present invention, there is provided a reusable thermal warming garment having at least one heating element matrix including a sheet of polyethylene film having upper and lower sides; at least one printed circuit associated with one side of the sheet of polyethylene film; a polypropylene cover extending over the at least one printed circuit at said one side of the sheet of polyethylene film and means for connecting the at least one heating element matrix to a power source.

The present invention creates a personal environment of comforting warmth and prevents its user from developing hypothermia by providing warmth by means of a disposable, single-use thermal warming garment which preferably operates at approximately 100 degrees Fahrenheit. The thermal warming garment is advantageously powered by a disposable or rechargeable 12 volt direct current battery package. An optional thermostat is advantageously located in the middle of a heating element matrix of the thermal warming garment and is connected to a temperature controller which controls the flow of current so that the temperature of the thermal warming garment remains preferably approximately 100 degrees Fahrenheit.

These, and other objects and advantages of the present invention, will become apparent as the same becomes better understood from the Detailed Description and the accompanying drawings.

### BRIEF DESCRIPTION OF THE DRAWINGS

Reference is now made to the drawings which illustrate the best known mode for carrying out the invention and wherein similar reference characters indicate the same parts throughout the several views.

FIG. 1 is a perspective view showing a thermal warming garment for user temperature management;

FIG. 2 is an enlarged view of a top portion of the thermal warming garment according to FIG. 1;

FIG. 3 is an enlarged view of foot portions of the thermal warming garment according to FIG. 1;

FIG. 4 is a an illustration of an ink pattern for a heating element matrix having a connector on a left side;

FIG. 5 is an illustration of an ink pattern for a heating element matrix having a connector on a right side portion;

FIG. 6 is an illustration of an ink pattern for a heating element matrix for the foot portions of the thermal warming garment;

FIG. 7 is a cross-sectional view of a plastic film and printed circuit;

FIG. 8 is a cross-sectional view of an assembled heating element matrix having two of the plastic films and the printed circuit therein;

FIG. 9 is an exploded cross-sectional view of the heating element matrix according to FIG. 8;

FIG. 10 is a sectional view taken along B-B in FIG. 11;

FIG. 11 is a sectional view of the thermal warming garment showing an alternative embodiment;

FIG. 12 is a sectional view of the thermal warming garment showing a wire held by an adhesive; and

FIG. 13 is a perspective view taken from the left side showing the left heating element matrix of the top portion.

### DETAILED DESCRIPTION

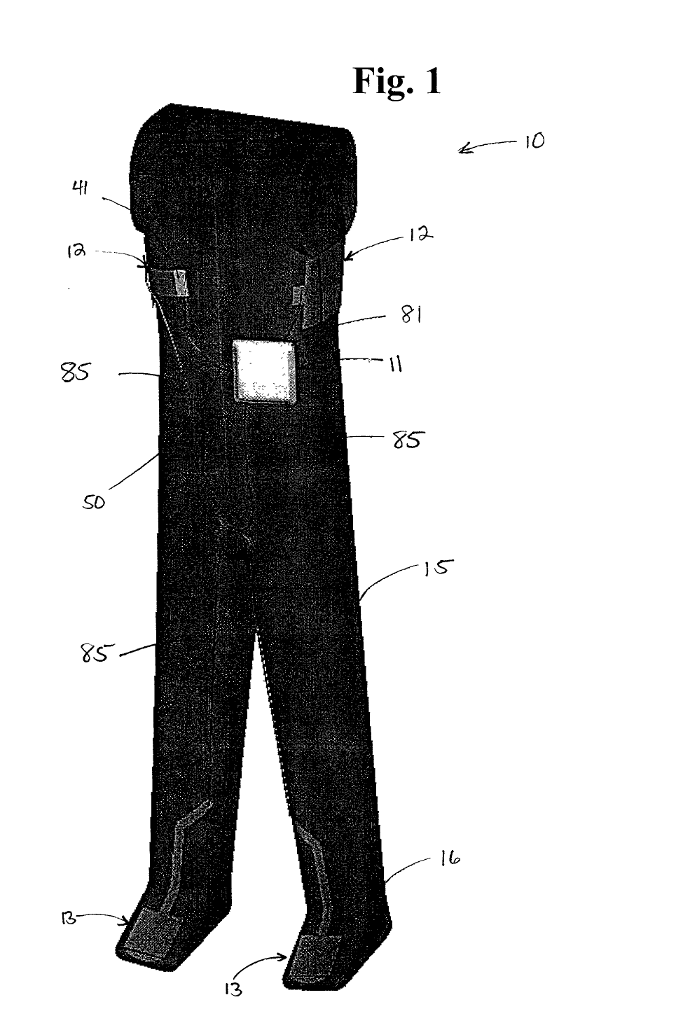

FIG. 1 shows a thermal warming garment 10 having a battery power pack 11 operatively attached thereto. The thermal warming garment 10 has imbedded heating element matrixes 12, 13. The thermal warming garment 10 is manufactured in various sizes, to fit substantially all shapes and sizes. The heating element matrixes 12, 13 can vary in size, quantity and location depending upon the size and particular use of the thermal warming garment 10. The size of the thermal warming garment 10 and the heating element matrixes 12, 13 is not limiting, because it is obvious that the sizes will vary according to the size of the user. In a preferred embodiment, the thermal warming garment 10 is constructed of a material which is a non-woven polypropylene base fabric, such as is employed in disposable surgical drapes and gowns. In alternative embodiments, the thermal warming garment 10 may be constructed of materials that are suitable for repeat usage, such as cotton, goose down or other materials. The color of the thermal warming garment 10 is not meant to be limiting. Various colors and combination of colors can be used. For example, a camouflaged thermal warming garment 10 may be desirable for hunters or wildlife spectators.

In one preferred embodiment, the thermal warming garment 10 has a top portion 14 and a lower portion 15, wherein the lower portion 15 has foot portions 16 integrally attached thereto. In alternative embodiments, the thermal warming garment 10 may be a unitary structure or divided into various other configurations, such as a configuration having the top portion 14, the lower portion 15 and the foot portions 16, wherein each respective portion is separate. It is obvious to those skilled in the art that the configuration and its portions making up the thermal warming garment 10 can vary, and it is not meant to be limiting.

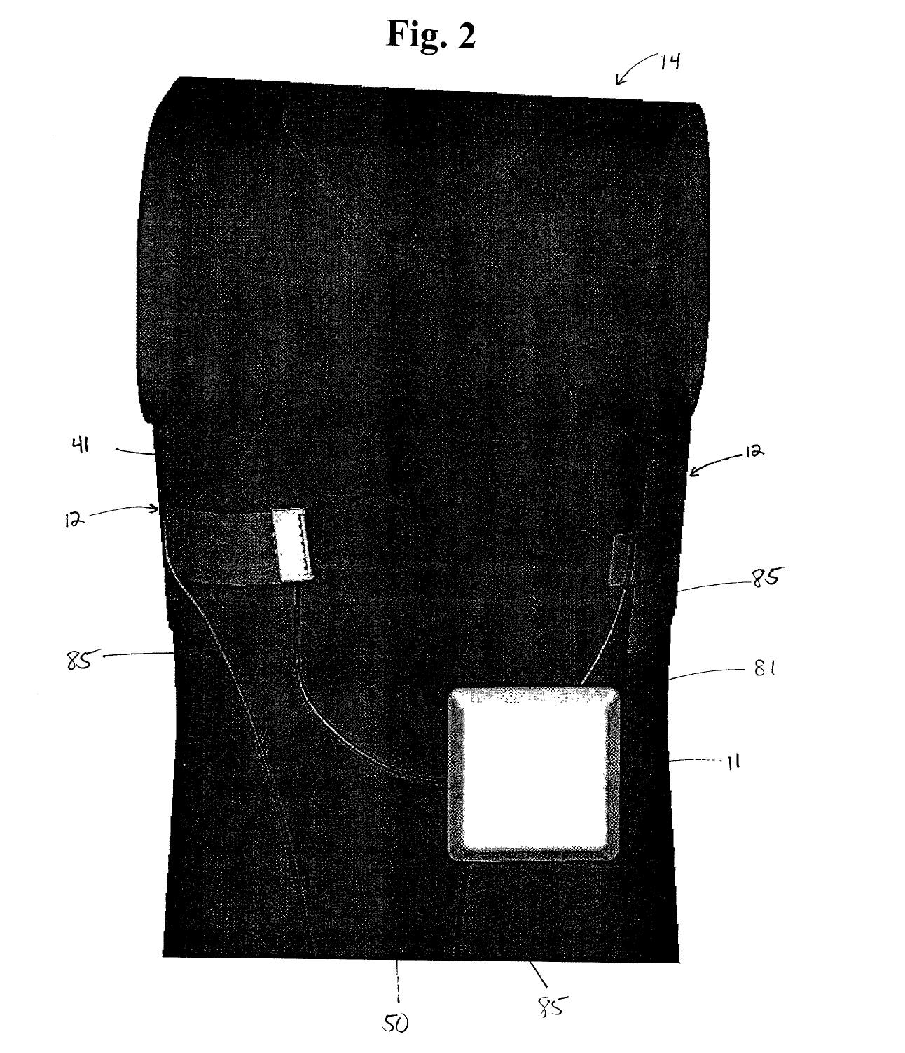

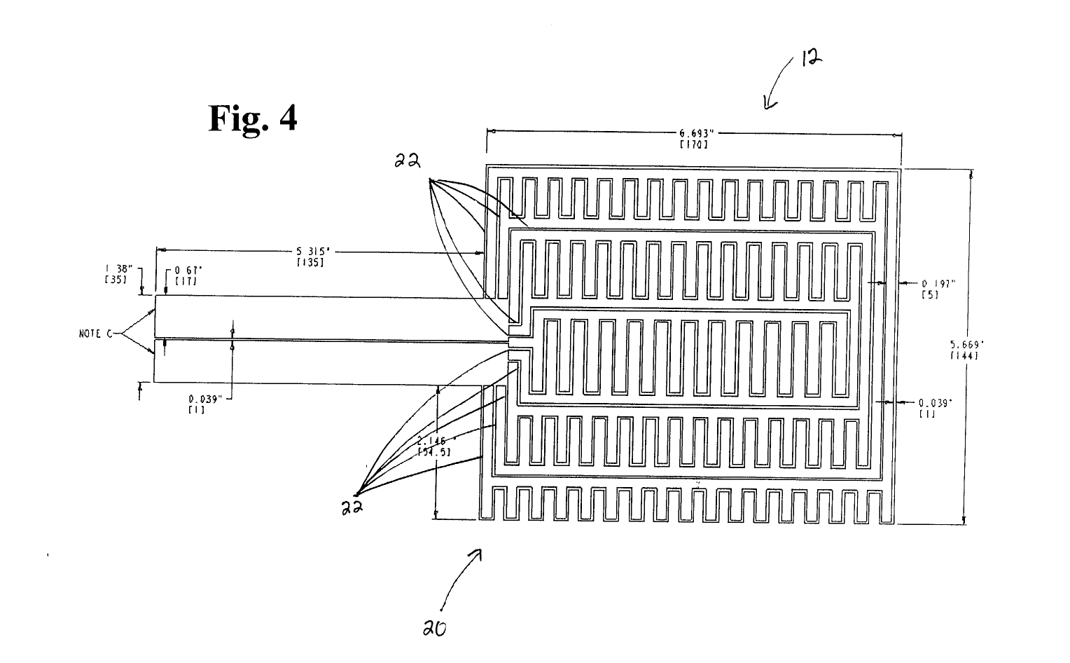

Turning now to FIG. 2, the top portion 14 has the heating element matrixes 12 shown in FIGS. 4 & 5 operatively attached thereto. In the preferred embodiment shown, two of the heating element matrixes 12 are embedded into the top portion 14 of the thermal warming garment 10, and below the armpits of the user. In alternative embodiments, the number, size and location of the heating element matrixes 12 are varied.

The shown preferred embodiment has a lower portion 15 that does not include the heating element matrixes 12, 13. However, the heating element matrixes 12, 13 can be used and the number, size and location of the heating element matrixes 12, 13 can be varied.

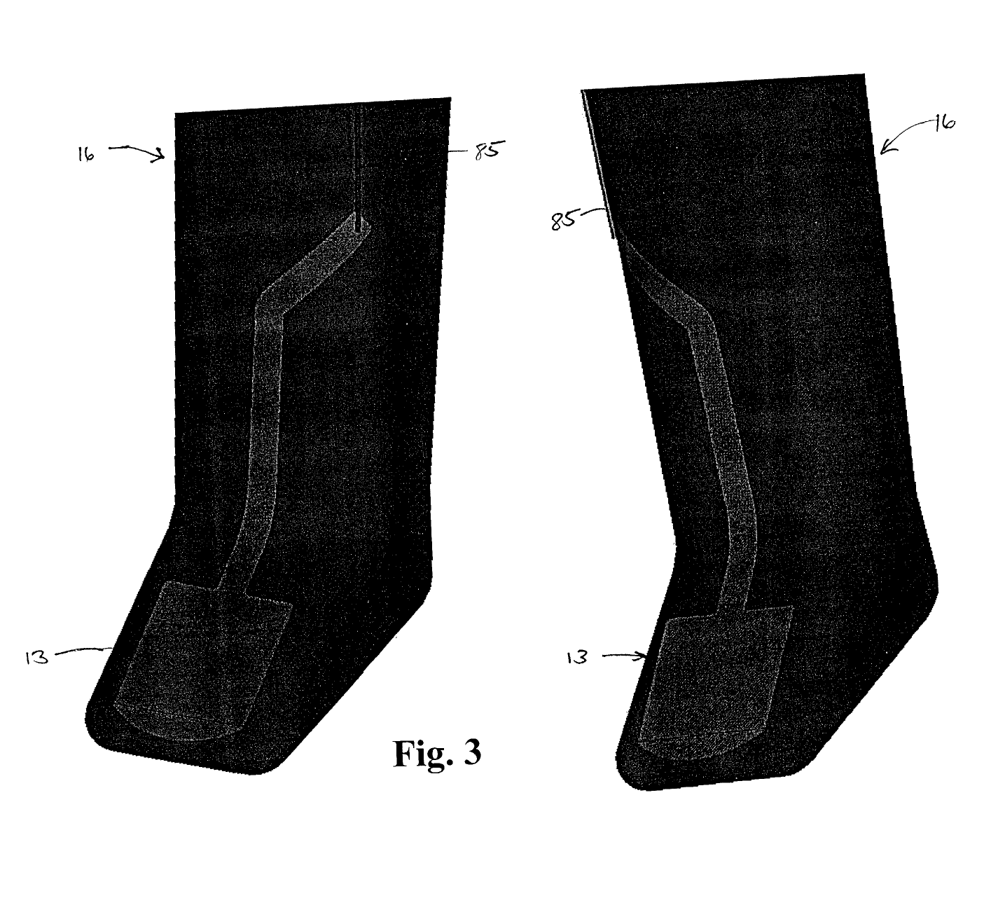

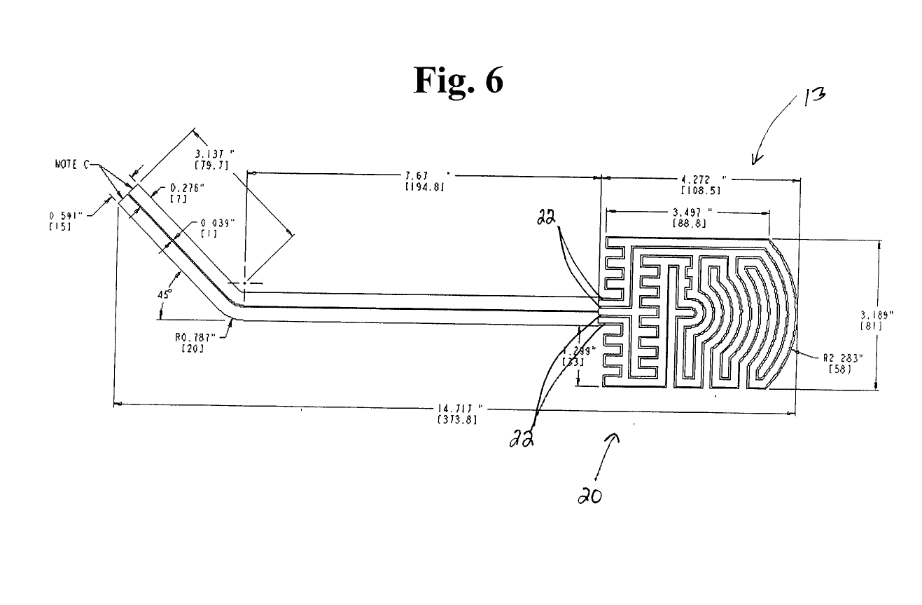

FIG. 3 shows foot portions 16 having the heating element matrixes 13 shown in FIG. 6, operatively attached thereto. In the preferred embodiment, there is one of the heating element matrixes 13 embedded into each of the foot portions 16. Preferably, the heating element matrixes 13 are positioned above the user's feet. In alternative embodiments, the number, size and location of the heating element matrix 13 are varied.

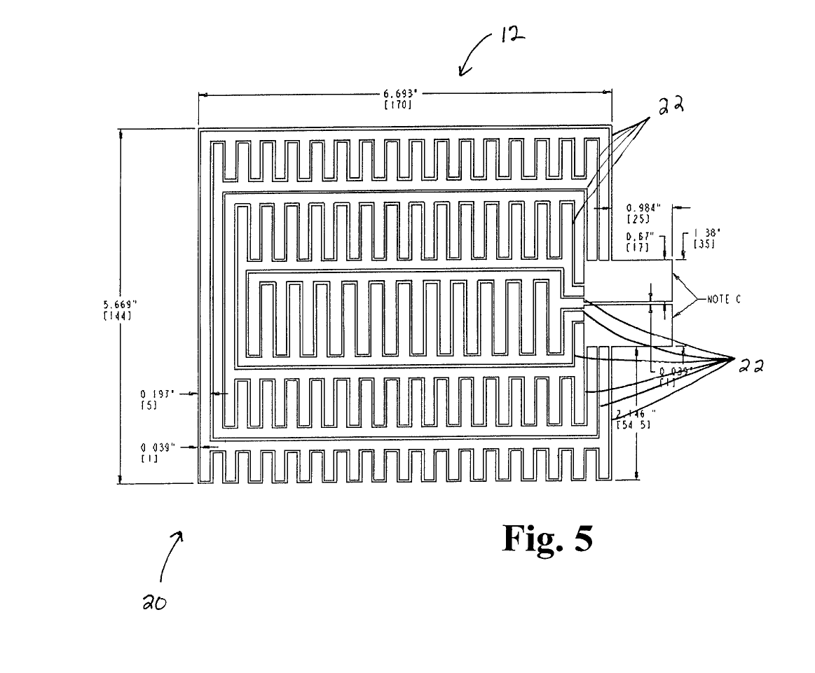

The battery power pack 11 is connected to at least one of the heating element matrixes 12, 13 and the heating element matrixes 12, 13 are all operatively connected to each other by connecting wires or cords 85. In the preferred embodiment, the connecting wires or cords 85 are not connected directly to the power pack 11 but may pass under the same. The heating element matrixes 12, 13 have printed circuits 20 as shown in FIGS. 4, 5 and 6. In the preferred embodiment, the heating element matrixes 12, 13 are strategically placed in locations where the user's skin is thin. For example, the heating element matrixes 12, 13 at the top portion 14 are placed below the armpits and the heating element matrixes 13 in the foot portions 16 are placed above the feet. The number, location and size of the heating element matrixes 12, 13 can be varied to fit any particular situation, individual or other criteria.

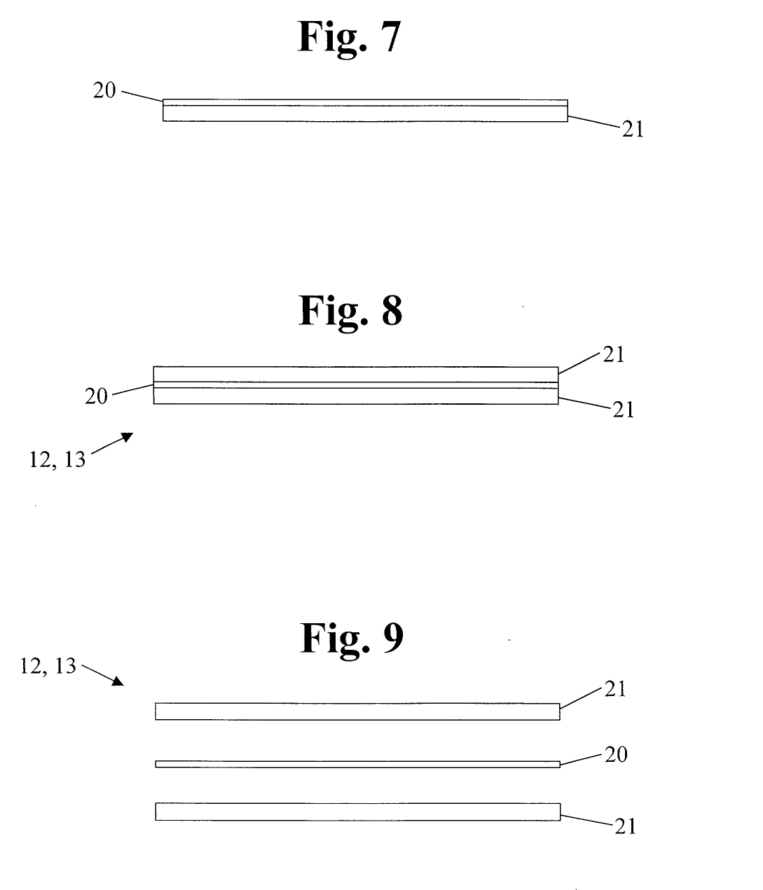

FIGS. 4, 5 and 6 show the heating element matrixes 12, 13. In the preferred embodiment, the printed circuits 20 are made of ink printed on one side of a plastic film 21, as shown in FIG. 7. Although the type of ink can vary, the ink used in the preferred embodiment is silver conductive ink. More specifically, the ink used in the preferred embodiment is Electodag® 427SS. Electodag® is the registered trademark of Acheson Industries, Inc., located at 511 Fort Street, Suite 315, Port Huron, Mich. 48060. Electodag® 427SS is a conductive, silk-screenable coating having finely divided silver particles dispersed in a thermoplastic resin. Carbon ink alone is not desirable because it becomes too brittle after it dries. In alternative embodiments, conductive inks are used. The printed circuits 20 have a plurality of individual circuits 22 having lengths that are approximately the same length. However, the lengths and number of the plurality of the individual circuits 22 can vary. The benefit of having the lengths approximately the same is the reduction of “hot spots” along the printed circuits 20. The printed circuits 20 on one side of the plastic film 21 are covered with a second sheet of the plastic film 21 as shown in FIG. 8. FIG. 9 is an exploded view showing the plastic films 21 and the printed circuits 20. The two sheets of the plastic films 21 sandwich or encase the printed circuits 20 and are held together by an adhesive. The two sheets of the plastic film 21 preclude water from penetrating and contacting the printed circuits 20 and are sealed together having the printed circuits 20 therein, so that water, liquid and moisture are precluded from contacting the printed circuits 20 in the area between the plastic films 21. The heating element matrixes 12, 13 are completely water-resistant, thus precluding water from contacting the printed circuits 20.

In the preferred embodiment, the two sheets of plastic film 21 are polyester. Silver conductive ink is printed on a 5 mil (0.005 inch) thick sheet of polyester, and a 1 mil (0.001 inch) thick sheet of polyester is placed on top of the printed side of the 5 mil (0.005 inch) thick sheet of polyester, wherein the 1 mil (0.001 inch) thick sheet of polyester has a cold laminate. The cold laminate has an adhesive thereon. The cold laminate side of the 1 mil (0.001 inch) thick sheet of polyester is placed on the printed side of the 5 mil (0.005 inch) thick sheet of polyester. When placed together, the two sheets of polyester are laminated.

In an alternative embodiment, MYLAR® is used as the two sheets of plastic film 21. MYLAR® is a registered trademark of E. I. Dupont de Nemours and Company Corporation located at 1007 Market Street, Wilmington, Del. 19898.

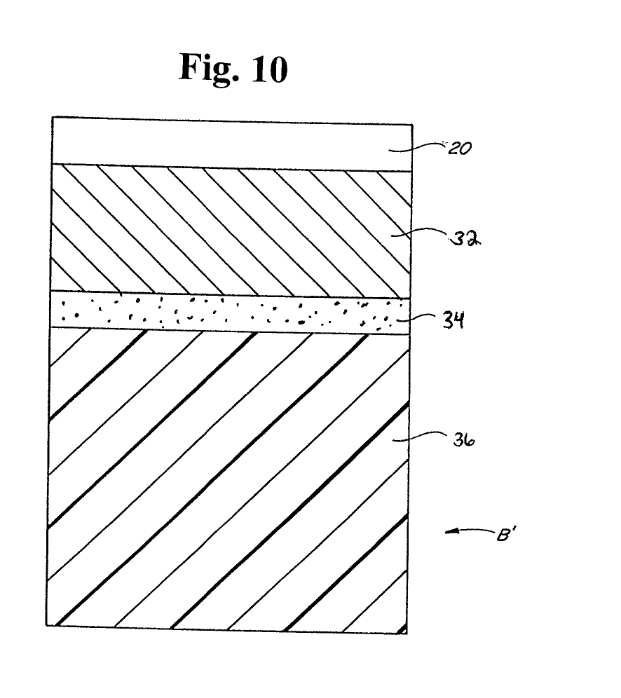

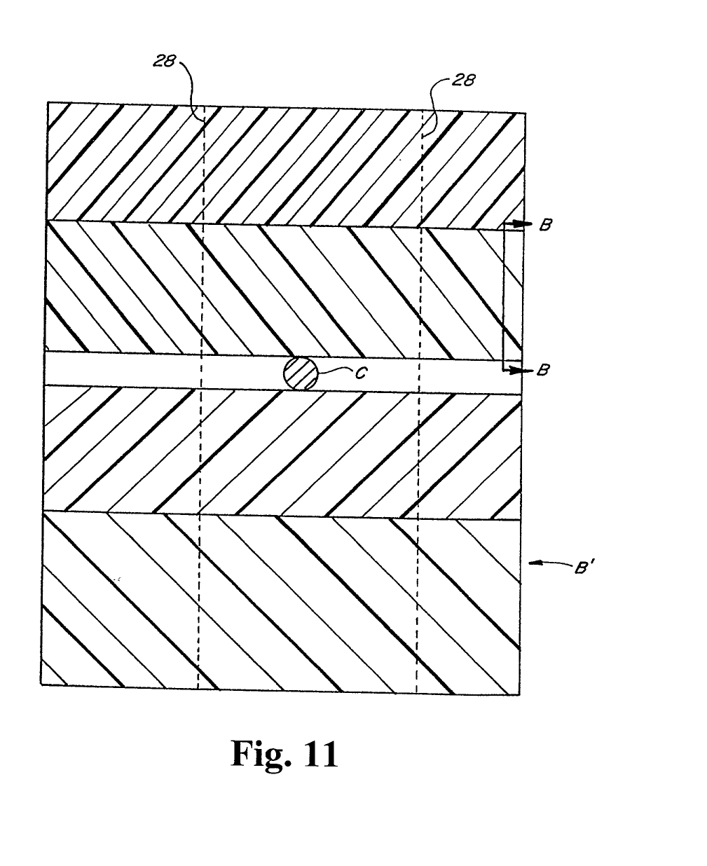

In an alternative embodiment, CURLAM® is used in the heating elements matrixes 12, 13. FIG. 10 is a sectional view along B-B of FIG. 11 of a film B′. The film B′ is CURLAM® Grade 8019-I protective packaging film, which is a flexible, non-formed web that meets the requirements for a food contact material under the Food Additive Regulations. CURLAM® is a registered trademark of Curwood, Inc. of Oshkosh, Wis. The CURLAM® Grade 8019-I protective packaging film B′ includes a layer 36 of 2.5 mil (0.0025 inch) linear low density polyethylene (LLDPE), and a layer 32 of 48 ga. metallized polyethylene terephthalate (PET) held by an intermediate layer 34 of adhesive. Conveniently, the layer 32 can have the printed circuits 20. The heating element matrixes 12, 13 are formed by a plurality of the individual circuits 22 printed with ink on the layer of metallized polyethylene terephthalate. The types of ink were described in the preferred embodiment described above. This design results in a very flexible and extremely low-profile, low weight blanket. The printed circuits 20 follow the basic layout of the wire matrix described above.

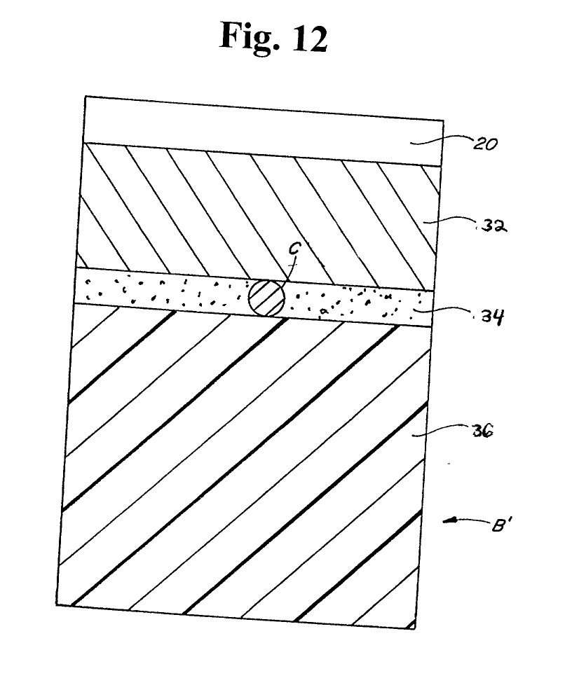

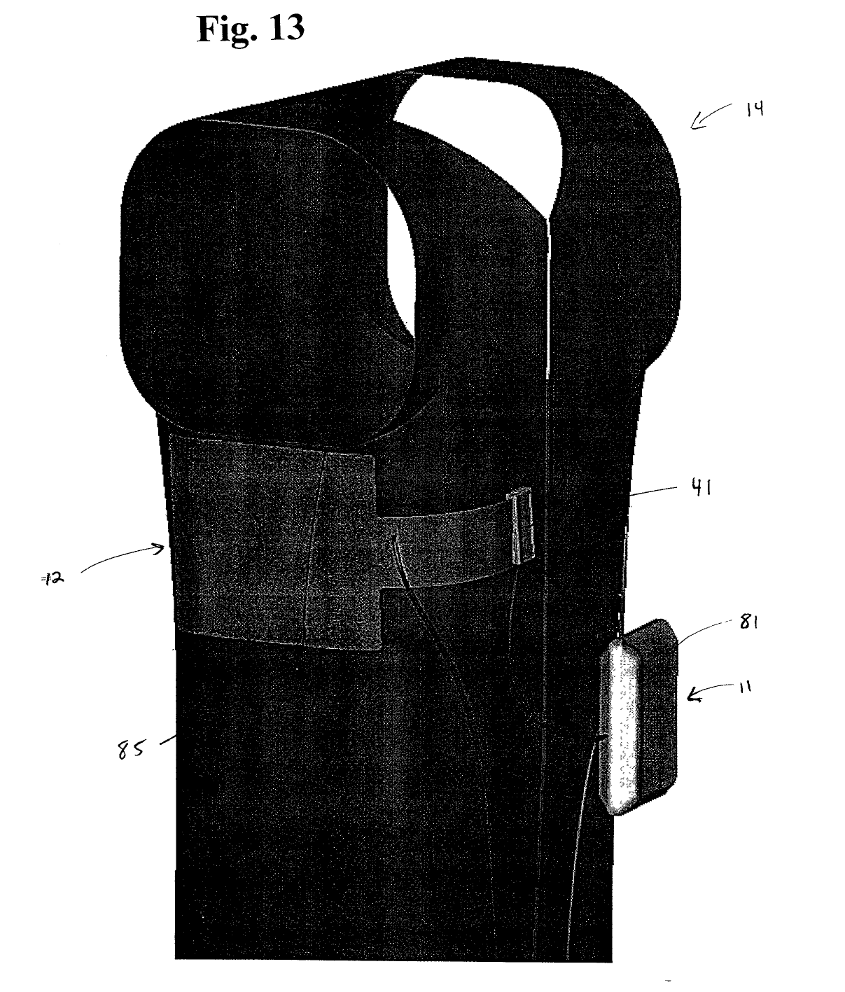

In an alternative embodiment, the heating element matrixes 12, 13 have wires 40 that are encapsulated between two thin sheets of non-flammable reflective plastic film B′. In one embodiment shown in FIG. 12, the heating element matrixes 12, 13 are placed between the plastic sheets and stitched into the thermal warming garment 10. In an alternative embodiment, a glue is used to secure the film B′ and to encapsulate the wires 40. The encapsulating glue is Scotch-Grip 4475 Plastic Adhesive. When this glue is thoroughly dry, it is not flammable and will burn only when subjected to a flame or temperature sufficient to cause thermal decomposition of the adhesive, which occurs at about 350 degrees Fahrenheit. The wires 40 are 24 gauge plastic coated, seven strand hookup wire and are designed according to FIGS. 4, 5, and 6 to prevent hot spots. The heating element matrixes 12, 13 are advantageously within the layers of the plastic film B′. The encapsulated wires 40 of the heating element matrixes 12, 13 are waterproof.

In the preferred embodiment, the thermal warming garment 10 is powered by the battery power pack 11. The battery power pack 11 is removably attached to the thermal warming garment 10. The battery power pack 11 has a conductive wire 50 for supplying current to the heating element matrixes 12, 13, thereby providing heat to the thermal warming garment 10. In the preferred embodiment, the battery power pack 11 has a battery used in a 12 volt system having at least a 2.2 amp-hour cell or at least a total 2.2 amp-hour rating. The thermal warming garment 10 has a maximum power draw of 2.5 amps, with an average operating draw of 1.9 amps. With a fully charged battery, the thermal warming garment 10 will reach its target temperature (i.e. 100 degrees Fahrenheit) in approximately 5 minutes and has an operating temperature range preferably between 90 and 104 degrees Fahrenheit. Specifically, in the preferred embodiment, the battery power pack 11 is a NICAD or nickel cadmium rechargeable battery that meets the aforementioned specifications. In alternative embodiments, a Lithium battery or lead acid is used that meet the aforementioned specifications. However, it is important to note that the battery specifications are for the preferred embodiment and these parameters are not meant to be limiting.

In another alternative embodiment, the battery is carried, because of its large size, for use in 12 volt systems for extended periods of use. In yet another alternative embodiment, the thermal warming garment 10 is powered by a cigarette lighter receptacle, wherein the cigarette lighter receptacle serves as the power source. Current is supplied from the battery power pack 11 to the conductive wire 50. The conductive wire 50 is either permanently or operatively attached to the heating element matrixes 12, 13 of the thermal warming garment 10. If the conductive wire 50 is not permanently attached to the heating element matrixes 12, 13, the conductive wire 50 is reusable and operatively attached to the heating element matrixes 12, 13 via a connector 41. If the conductive wire 50 is integral to the heating element matrixes 12, 13, it is advantageously disposable if used with the thermal warming garment 10 in the embodiment having the disposable material. Other embodiments of the thermal warming garment may also include an AC/DC converter to allow a standard 110V AC wall outlet to act as the power source.

In alternative embodiments, the thermal warming garment 10 is controlled by a timer circuit controlled by a two-position switch (not shown). The timer has an “on” mode that allows current to flow for certain intervals of time, and it has an “off” mode that precludes current from flowing for certain intervals of time.

In an alternative embodiment, the temperature of the thermal warming garment 10 is regulated at approximately 100 degrees Fahrenheit by a temperature controller (not shown) and, advantageously, by a thermocouple (not shown). Devices other than the thermocouple may be used as a thermostat. The temperature is controlled from 90 to 104 degrees Fahrenheit. The temperature controller includes a circuit board (not shown) which is located inside an enclosure 81, wherein the enclosure 81 is hermetically sealed. The circuit board is operatively connected to a pair of sealed, maintenance free, rechargeable volt batteries (not shown) inside the enclosure 81 to regulate the flow of current to the heating matrixes 12, 13. The thermocouple is advantageously in the form of a probe encapsulated along with the heating element matrixes 12, 13 as described above.

In use, the thermal warming garment 10 is heated to approximately 100 degrees Fahrenheit. It is designed to be disposable or reusable. Multiple use is dependent on the material used for and the user's treatment of the thermal warming garment 10. For best results, the user places the thermal warming garment 10 over his/her long underwear or underwear as the case may be. After the thermal warming garment 10 is in place, the user operatively connects one end of the conductive wire 50 into the battery power pack 11. If not integral to the thermal warming garment 10, the other end of the conductive wire 50 is operatively connected to the connector 41. Thereafter, the user turns the battery power pack 11 on. If the timer is incorporated into the battery power pack 11, the timer will allow current to flow for certain intervals of time, and it will preclude current from flowing for certain intervals of time.

If rechargeable batteries are used, it is recommended that the batteries be recharged after each use. There are many battery charges available for this purpose.

In the preferred embodiment, the conductive wire 50 may advantageously have a first end attached to the sheet of plastic film 21 and electrically connected to one of the heating element matrixes 12, 13, and a second end detachably connected to a power source. Furthermore, the first end of the conductive wire 50 may be attached to the sheet of plastic film 21 by a suitable adhesive. The first end, alternatively, may include a receptacle designed to accept a plug attached to the end of the sheet of plastic film 21. This plug may also be attached to the sheet of plastic film 21 by a suitable adhesive or by soldering. The second end of the conductive wire 50 may be advantageously provided with a plug suitable for insertion into a cigarette lighter receptacle, allowing the cigarette lighter to function as the power source.

It is now deemed apparent that there has been described preferred embodiments of the thermal warming garment 10 of the present invention. The battery power pack 11 is not disposable and has been described. However, other ways of delivering direct current to the thermal warming garment 10 are contemplated.

While a preferred embodiment of the invention has herein been illustrated and described, this has been done by way of illustration and not limitation, and the invention should not be limited except as required by the scope of the appended claims.

I claim:

1. A thermal warming garment for user temperature management, including at least one heating element matrix associated with the thermal warming garment, wherein the at least one heating element matrix has
a sheet of plastic film having upper and lower sides and at least one printed circuit associated with one side of the sheet of plastic film;
a cover extending over the printed circuit side of the sheet of the plastic film; and
means for connecting the at least one heating element matrix to a power source.

2. The thermal warming garment according to claim 1, wherein the sheet of plastic film and the cover comprise polyester.

3. The thermal warming garment according to claim 2, wherein the printed circuit comprises conductive ink.

4. The thermal warming garment according to claim 2, wherein the printed circuit comprises a silver-based conductive ink.

5. The thermal warming garment according to claim 1, wherein the sheet of plastic film and the cover comprise polyethylene.

6. The thermal warming garment according to claim 5, wherein the printed circuit comprises conductive ink.

7. The thermal warming garment according to claim 5, wherein the printed circuit comprises a silver-based conductive ink.

8. The thermal warming garment according to claim 1, wherein the sheet of plastic film and the cover comprise MYLAR®.

9. The thermal warming garment according to claim 1, wherein the sheet of plastic film and the cover comprise CURLAM®.

10. The thermal warming garment according to claim 1, wherein the at least one heating element matrix is water resistant.

11. The thermal warming garment according to claim 1, wherein the thermal warming garment comprises a top portion and a lower portion, the lower portion having integral feet portions.

12. The thermal warming garment according to claim 1, wherein the thermal warming garment comprises an upper section, a lower section and feet portions.

13. The thermal warming garment according to claim 1, wherein the thermal warming garment has a unitary structure comprising an upper section, a lower section and feet sections.

14. The thermal warming garment according to claim 1, wherein the sheet of plastic film is comprised of a flexible, non-formed web having a layer of linear low density polyethylene and a layer of metallized polyethylene terephthalate.

15. The thermal warming garment according to claim 14, wherein the circuit is printed on the layer of metallized polyethylene terephthalate.

16. The thermal warming garment according to claim 2, wherein the circuit is printed on the sheet of plastic film comprising polyester.

17. The thermal warming garment according to claim 1, wherein said thermal warming garment has two sheets of plastic film and the heating matrixes include wires encapsulated between the two sheets of plastic film.

18. The thermal warming garment according to claim 1, wherein the power source is a direct current power source.

19. The thermal warming garment according to claim 18, wherein the direct current power source is comprised of a rechargeable battery.

20. The thermal warming garment according to claim 19, wherein the rechargeable battery is a Nickel Cadmium battery.

21. The thermal warming garment according to claim 18, wherein the direct current power source is comprised of a non-rechargeable battery.

22. The thermal warming garment according to claim 19, including a timer circuit controlled by a two-position switch which regulates a supply of power to the at least one heating element matrix in a timing sequence.

23. The thermal warming garment according to claim 18, including an AC/DC converter to allow a standard 110V AC wall outlet to act as the power source.

24. The thermal warming garment according to claim 1, wherein the means for connecting the power source with the at least one heating element matrix comprises a conductive wire with a first end attached to the sheet of plastic film, said first end being electrically connected with the heating element matrixes, and a second end detachably connected with the power source.

25. The thermal warming garment according to claim 25, wherein the first end of the conductive wire is attached to the sheet of plastic film by an adhesive.

26. The thermal warming garment according to claim 1, wherein the means for connecting the power source with the at least one heating element matrix includes a plug attached to the sheet of plastic film, said plug being electrically connected with the heating matrix, and a conductive wire with first and second ends, wherein said conductive wire has a receptacle at its first end designed to accept the plug and the second end of said conductive wire is detachably connected with the power source.

27. The thermal warming garment according to claim 26, wherein the plug is attached to the sheet of plastic film by an adhesive.

28. The thermal warming garment according to claim 26, wherein the plug is soldered to the sheet of plastic film.

29. The thermal warming garment according to claim 26, wherein the second end of the conductive wire is provided with a second plug suitable for insertion into a cigarette lighter receptacle, allowing the cigarette lighter to function as the power source.

30. The thermal warming garment according to claim 1, wherein the means for controlling the temperature of the at least one heating element matrix includes a temperature sensing means in communication with the at least one heating element matrix and a temperature controller connected with the temperature sensing means.

31. A thermal warming garment for user temperature management,
including at least one heating element matrix associated with the thermal warming garment wherein the at least one heating element matrix has
a sheet of polyester film having upper and lower sides;
at least one printed circuit associated with one side of the sheet of the polyester film;
a polyester cover over the printed circuit side of the sheet of polyester film; and
means for connecting the at least one heating element matrix to a power source.

32. The thermal warming garment according to claim 31, wherein the power source is comprised of a rechargeable battery.

33. The thermal warming garment according to claim 32, wherein the rechargeable battery is a Nickel Cadmium battery.

34. The thermal warming garment according to claim 31, wherein the power source is comprised of a non-rechargeable battery.

35. The thermal warming garment according to claim 31, further including a timer circuit controlled by a two-position switch which regulates a supply of power to the at least one heating element matrix in a timing sequence.

36. A thermal warming garment for user temperature management, including at least one heating element matrix associated with the thermal warming garment, wherein the at least one heating element matrix has a sheet of polyethylene film having
upper and lower sides and at least one printed circuit associated with one side of the sheet of the polyethylene film,
a polypropylene cover over the printed circuit side of the sheet of polyethylene film; and
means for connecting the at least one heating element matrix to a power source.

37. The thermal warming garment according to claim 36, wherein the power source is comprised of a rechargeable battery.

38. The thermal warming garment according to claim 37, wherein the rechargeable battery is a Nickel Cadmium battery.

39. The thermal warming garment according to claim 36, wherein the power source is comprised of a non-rechargeable battery.

40. The thermal warming garment according to claim 36, further including a timer circuit controlled by a two-position switch which regulates a supply of power to the at least one heating element matrix in a timing sequence.

41. The thermal warming garment according to claim 1, including means for controlling temperature of the printed circuit.

42. The thermal warming garment according to claim 36, including means for controlling temperature of the printed circuit.

43. The thermal warming garment according to claim 42, wherein the means for controlling temperature of the printed circuit includes temperature sensing means in communication with the heating matrixes and a temperature controller connected with a temperature sensor.
